(19) United States
(12) Patent Application Publication
(10) Pub. No.: US 2022/0260698 A1
(43) Pub. Date: Aug. 18, 2022

(54) RADAR DISTANCE MEASURING DEVICE AND RADAR DISTANCE MEASURING METHOD

(71) Applicant: RENESAS ELECTRONICS CORPORATION, Tokyo (JP)

(72) Inventors: Nobuyuki MORIKOSHI, Tokyo (JP); Takashi OSHIMA, Tokyo (JP); Takahiro NAKAMURA, Tokyo (JP)

(21) Appl. No.: 17/666,877

(22) Filed: Feb. 8, 2022

(30) Foreign Application Priority Data
Feb. 18, 2021 (JP) 2021-024228

(51) Int. Cl. G01S 13/28; G01S 7/35

(52) U.S. Cl. CPC G01S 13/282; G01S 7/4056; G01S 7/352

(57) ABSTRACT

A radar distance measuring device having a BPF type ΣΔADC and capable of controlling a band of a BBF and modulation setting of a chirp signal in conjunction therewith is provided. A chirp signal generated by a synthesizer is distributed to a transmission antenna and each of mixers at a reception side. The chirp signal is amplified and irradiated from the transmission antenna to an object as radar. The radar reflected by the objects received by reception antennas, and is then mixed with the chirp signal from the synthesizer by the mixers to generate IF signals. These IF signals are respectively outputted to ADCs via anti-aliasing filters. Each of the ADCs is as oversampling ΣΔADC. The IF signals are sampled by the ΣΔADC, and are converted into a digital signal.

### CROSS-REFERENCE TO RELATED APPLICATIONS

The disclosure of Japanese Patent Application No. 2021-024228 filed on Feb. 18, 2021 including the specification, drawings and abstract is incorporated herein by reference in its entirety.

### BACKGROUND

The present invention relates to a radar distance measuring device and a radar distance measuring method.

An FMCW radar system using a. frequency modulated continuous wave (FMCW: Frequency Modulated Continuous Wave) is known as a technique for measuring a distance and an angle to an object (for example, see Non-Patent document 1). In the FMCW radar system, an intermediate frequency signal obtained by combining a transmitted signal with a received signal reflected by an object is converted into a digital signal by an A/D converter, and a distance and an angle to the object are measured on the basis of the digital. signal.

Further, recent years, sigma-delta (ZA) architecture is becoming more and more popular as a technology for realizing a high-resolution A/D converter (ADC) in a mixed signal (digital/analog mixed) VLSI process. A primary ΣΔADC is known as such an A/D converter (for example, see Non-Patent document 2). A general primary ΣΔADC includes a ΣΔ modulator composed of an integrator circuit and a comparator, and is characterized by oversampling and noise shaving.

There are disclosed techniques listed below.
[Non-Patent Document 1] Sandeep Rao, “Basic of millimeter wave sensor”, Texas Instruments
[Non-Patent Document 2] “Principle of ΣΔ ADC/DAC (Application Note AN-283)” Analog Devices

### SUMMARY

However, in the FMCW radar system, there is a problem that it is difficult to achieve both measurement of a long distance and high resolution for distance due to the ability of an ADC in an RF system.

The other object and new feature will become apparent from description of the present specification and the accompanying drawings.

The present invention has been made in view of the above problems, and it is one of objects of the present invention to provide a radar distance measuring device having a Band Path Filter type (hereinafter, referred to as a “BPF type”) ΣΔADC and a radar distance measuring method, which are capable of controlling a band of a BPF and modulation setting of a chirp signal in conjuncts on therewith.

According to one embodiment, a radar distance measuring device 7 for measuring at least one of a distance and an angle to an object by radar is provided. The radar distance measuring device includes: a synthesizer configured to generate and output a chirp signal; a transmission antenna configured to irradiate the chirp signal generated by the synthesizer to an object as radar; one or more reception antennas configured to receive the chirp signal reflected by the object; one or more mixers configured to mix the chirp signal generated by the synthesizer with the chirp signal reflected by the object to generate an intermediate frequency signal; and one or more AD converters configured to convert the intermediate frequency signal into a digital signal. Here, each of the one or more AD converters is a bandpass filter type ΣΔADC in which a bandpass filter is embedded, and the ΣΔADC is configured to sample the intermediate frequency signal on a basis of two bands of the bandpass filter.

According to one embodiment, it is possible to provide a radar distance measuring device and a radar distance measuring method capable of minimizing noise of a desired band by controlling a band of a BPF in a ΣΔADC and modulation band setting of a. chirp signal in conjunction therewith, and as a result, it is possible to secure a high S/N ratio without depending upon a modulation band of the chirp signal.

### BRIEF DESCRIPTION OF THE DRAWINGS

FIG. 1 is a block diagram illustrating a system configuration for explaining a problem of the present invention.

FIG. 2 a graph illustrating a relationship between noise shaving and a signal of an oversampling ΣΔADC.

FIG. 3 a block diagram illustrating one example of a configuration of a radar distance measuring device according to a first embodiment.

FIG. 4 is a block diagram illustrating details of a thinning circuit in the radar distance measuring device illustrated in FIG. 3.

FIG. 5A is a block diagram illustrating one example of the configuration of the radar distance measuring device according to the first embodiment.

FIGS. 5B and 5C are respectively graphs of rough detection and zoom detection obtained by this radar distance measuring device.

FIGS. 6A and 6B are graph views of rough detection and zoom detection obtained by a band of a BPF in the oversampling ΣΔADC.

FIGS. 7A and 7B are views illustrating a relationship between distance resolution and angle resolution.

FIG. 8 is a view illustrating a DC low frequency side characteristic of the BPF in the oversampling ΣΔADC.

FIGS. 9A and 9B are views illustrating a relationship between an oversampling ratio and a data rate of the oversampling ΣΔADC.

FIG. 10 is a block diagram illustrating one example of- a general thinning circuit.

FIGS. 11A-11E are views illustrating a frequency characteristic in a case where the general thinning circuit is used.

FIGS. 12A-12F are views illustrating a frequency characteristic of the thinning circuit used in the radar distance measuring device according to the first embodiment.

FIG. 13 a block diagram illustrating one example of a configuration of a radar distance measuring device according to a second embodiment.

FIG. 14 is a block diagram illustrating one example of a configuration of a radar distance measuring device according to a third embodiment.

### DETAILED DESCRIPTION

In embodiments described below, the invention will be described in a plurality of sections or embodiments when required as matter of convenience. However, these sections or embodiments are not irrelevant to each other unless otherwise stated, and the one relates to the entire or a part of the other as a modification example, details, or a supplementary explanation thereof. Further, in the embodiments described below, in a case of referring to the number of elements (including number of pieces, values, amount, range, and the like), the number of the elements is not limited to a specific number unless otherwise stated or except the case where the number is apparently limited to a. specific number in principle, and the number larger or smaller than the specified number may also be applicable. Moreover, in the embodiments described below, it goes without saying that the components (including element steps and the like) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Hereinafter, problems assumed by the present invention and the embodiments will be described in detail with reference to the drawings. Note that in all of the drawings for explaining the embodiments, the same reference numeral is assigned to members having the same function, and repeated explanation thereof will be omitted. Further, in the following embodiments, in principle, explanation of the same or similar will not be repeated unless otherwise necessary.

(Basic Configuration and Problems Thereof)

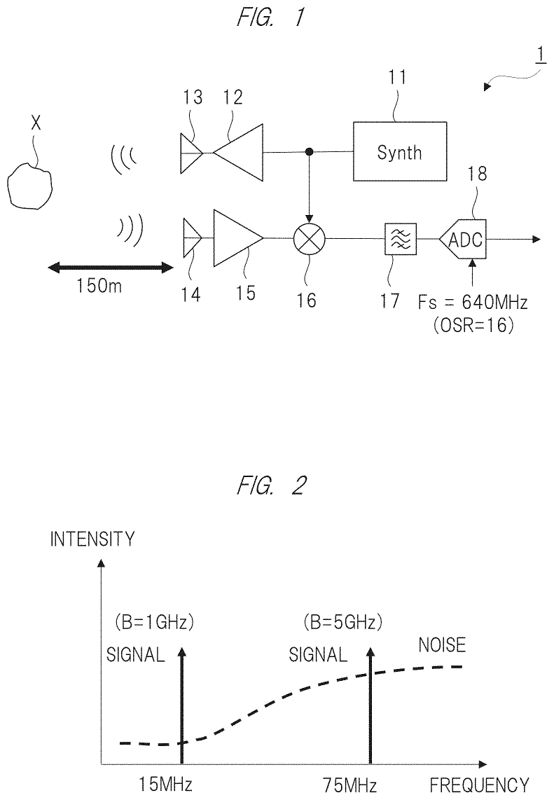

A basic configuration of a radar distance measuring device using an oversampling ΣΔADC and a problem in the radar distance measuring device will be described with reference to FIG. 1 and FIG. 2. FIG. 1 is a block diagram illustrating a system configuration for explaining a problem of the present invention. FIG. 2 is a graph illustrating a relationship between noise shaving and a signal of an oversampling ΣΔADC. In the present embodiment, a method of measuring a distance by a radar distance measuring device I illustrated in FIG. 1 when a distance to an object X is 150 m, for example, will be described using specific numerical values.

A configuration of the radar distance measuring device 1 will first he described. The radar distance measuring device 1 includes a synthesizer 11, a power amplifier 12, a transmission antenna 13, a reception antenna 14, a low noise amplifier 15, a mixer 16, an anti-aliasing filter 17, and an ADC 18. The synthesizer 11 is configured to generate a chirp signal, and output the generated chirp signal to the power amplifier 12 and the mixer 16. The power amplifier 12 is configured to amplify the chirp signal inputted from the synthesizer 11, and outputs the amplified chirp signal the transmission antenna 13. The transmission antenna 13 is configured to transmit (or irradiate) the amplified chirp signal toward the object X. The reception antenna 14 is configured t.o receive (or capture) the chirp signal reflected by the object X, and output the received chirp signal to the low noise amplifier 15. The low noise amplifier 15 is configured to amplify the reflected chirp signal received by the reception antenna 14, and output the amplified chirp signal to the mixer 16. The mixer 16 is configured to mix (or combine) the reflected chirp signal thus received with the chirp signal generated by the synthesizer 11 (that is, a transmitted signal) to generate an intermediate frequency signal (hereinafter, referred to as an “IF signal”), and output the intermediate frequency signal to the anti-aliasing filter 17. The anti-aliasing filter 17 is configured to execute filter processing so that aliasing noise is not generated, and output the signal after processing to the ADC 18. The ADC 18 is a ΣΔADC, and is configured to convert the analog signal inputted from the anti-aliasing filter 17 into a digital signal. Note that the chirp signal is a signal that expresses an amplitude or a frequency as a function of time.

As illustrated in FIG. 1, when a distance to the object X is 150 m, an oversampling frequency Fs of the ΣΔADC is set to 640 MHz, for example, by setting an oversampling ratio (OSR) to 16. Further, as illustrated as one example in Non-Patent document 1, when duration Tc=68 μs and a bandwidth B=1 GHz, distance resolution dr of a waveform of the chirp signal is calculated as 15 cm from a formula “dr=/2B”. Note that a symbol “c” is the speed of light. Further, the IF signal becomes a sine wave of “A×sin (2πf0t+Φ0)” and an IF frequency f0 becomes 15 MHz from a formula “f0=s2d/c”. Note that a symbol “d” is a distance to an object, and is 150 m in the present embodiment. Further, a symbol. “Φ0” is an initial phase of the IF signal.

Here, in a case where the bandwidth B of the chirp signal is changed from 1 GHz to 5 GHz in order increase the distance resolution dr, the distance resolution dr becomes 3 cm from the above formula, and the IF frequency f0 becomes 75 MHz from the above formula. A Nyquist frequency of the ADC 18 is 20 MHz when the oversampling ratio OSR is 16. Therefore, the radar distance measuring device 1 cannot correctly sample the IF signal of 75 MHz.

Further, since a sampling frequency of the ADC 18 cannot be changed significantly, the oversampling ratio OSR, must be changed slightly to raise the Nyquist frequency of the ADC 18.

Here, the oversampling ratio OSR is set to two, and the Nyquist frequency is set to 160 NH. FIG. 2 illustrates a relationship between noise and a chirp signal when the bandwidth B of the chirp signal is set. to each of 1 GHz and 5 GHz. In the present embodiment, since the oversampling frequency Fs of the ADC 18 is fixed at 640 MHz, noise shaving characteristic the same at any frequency. When the bandwidth B of the chirp signal is GHz, the IF frequency thereof is 15 MHz. As illustrated in FIG. 2, since a noise component is also small, it is possible to set the S/N ratio to be sufficiently high. On the other hand, when the bandwidth B of the chirp signal is 5 GHz, the IF frequency thereof is 75 MHz. As illustrated in FIG. 2, the noise component becomes large, which causes a problem that the S/N ratio is deteriorated.

In the embodiments below, a case where a band of a BPF and modulation setting of a chirp signal can be controlled in conjunction therewith by using a radar distance measuring device provided with a BPF type ΣΔADC will be described in detail.

### First Embodiment <Configuration of Radar Distance Measuring Device>

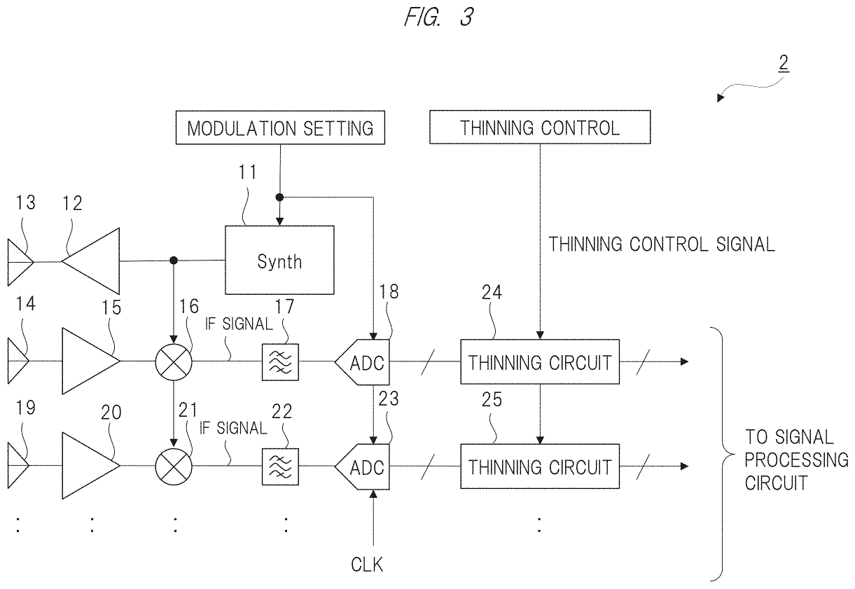

One example of a configuration of the radar distance measuring device according to the first embodiment will first be described. FIG. 3 is a block diagram illustrating one example of a configuration of the radar distance measuring device according to the first embodiment. In the present embodiment, a case where a transmission side has one channel and a resection side has a plurality of channels (in FIG. 3, two channels) will be described.

As illustrated in FIG. 3, a radar distance measuring device 2 according to the present embodiment includes a synthesizer 11, a power amplifier 12, a transmission antenna 13, two reception antennas 14 and 19, two low noise amplifiers 15 and 20, two mixers 16 and 21, two anti aliasing filters 17 and 22, two ADCs 18 and 23, and two thinning circuits 24 and 25.

A chirp signal generated by the synthesizer 11 is distributed to the power amplifier 12 provided at a transmission side and each of the mixers 16 and 21 provided at a reception side. The chirp signal inputted into the power amplifier 12 is amplified and irradiated from the transmission antenna 13 to an object (not illustrated in FIG. 3) as radar. The radar reflected by the object is received by the reception antennas 14 and 19, and is then amplified by the low noise amplifiers 15 and 20. The amplified radar is mixed with the chirp signal from the synthesizer 11 by the mixers 16 and 21 to generate IF signals. These IF signals are respectively subjected to filter processing by the anti-aliasing filters 17 and 22 so that aliasing noise is not generated, and are outputted to the ADCs 18 and 23.

Here, in the present embodiment, each of the ADCs 18 and 23 is an oversampling ΣΔADC, and each of the anti-aliasing filters 17 and 22 corresponds to a sampling frequency of the ΣΔADC. Then, the IF signals are respectively sampled by the ΣΔADCs via the anti-aliasing filters 17 and 22 based on the sampling frequency of the ZAADC, and are converted into digital signals. The digitized IF signals are subjected to signal processing via the thinning circuits 24 and 25 (will be described later) by signal processing circuits provided at a post stage such as a digital circuit or an MCU (not illustrated in FIG. 3). Further, modulation setting is subjected to the synthesizer 11 and the ADCs 18 and 23. By interlocking them with a frequency band (that is, a modulation bandwidth) of the chirp signal generated by the synthesizer 11, the oversampling ratio OSR of the ΣΔADC and a BPF band are controlled so as to minimize noise of a desired band.

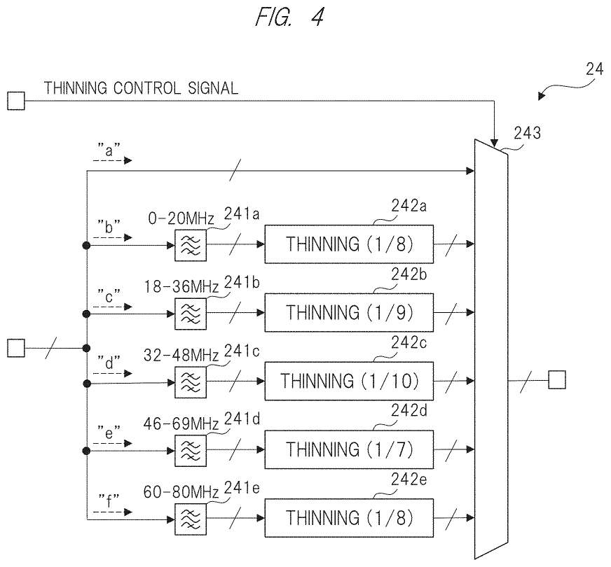

Here, an example of a configuration of the thinning circuits 24 and 25 will be described. FIG. 4 is a block diagram illustrating details of the thinning circuits 24 and 25 in the radar distance measuring device 2 illustrated in FIG. 3. Here, as a representative of them, the thinning circuit 24 will be described as an example. The thinning circuit 24 includes a BPF 241a and a thinning circuit 242a for a ⅛ thinning rate, which correspond to 0 to 20 MHz, a BPF 241b and a thinning circuit 242b for a 1/9 thinning rate, which correspond to 18 to 36 MHz, a BPF 241c and a thinning circuit 242c for a 1/10 thinning rate, which correspond to 32 to 48 MHz, a BPF 241d and a thinning circuit 242d for a 1/7 thinning rate, which correspond to 46 to 69 MHz, and a BPF 241e and a thinning circuit 242e for a ⅛ thinning rate, which correspond to 60 to 80 MHz, so as to respectively correspond to six paths “a” to “f”. Further, the thinning circuit 24 includes a selector 243 configured to select one input signal from six input signals respectively inputted via these paths “a” to “f” in accordance with a thinning control signal, and output the selected input signal.

An input signal from the ADC 18 that is the ΣΔADC is inputted into the selector 243 via the BPFs 241a to 241e and the thinning circuits 242a to 242e according to the corresponding thinning rate. Then, the selector 243 outputs only the signal of the band selected by the thinning control signal (any of the path “a” to the path “f”).

<Operation of Radar Distance Measuring Device>

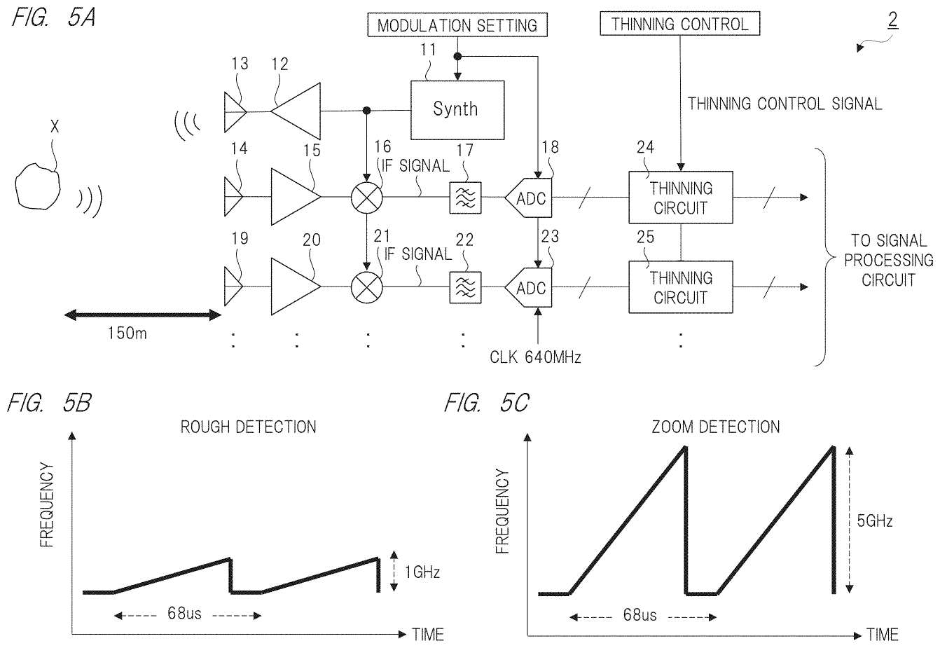

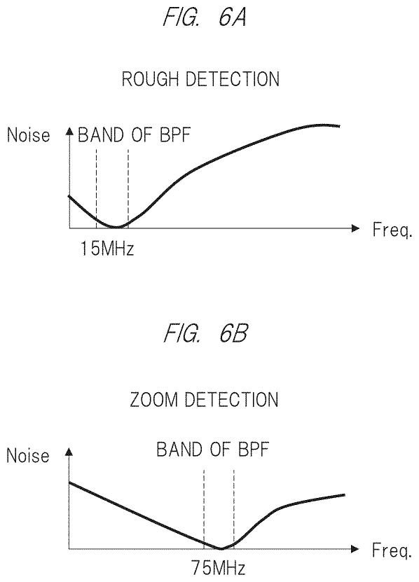

Next, an operation of the radar distance measuring device 2 according to the first embodiment will be described. FIG. 5A is a block diagram illustrating one example of the configuration of the radar distance measuring device according to the first embodiment. again. FIG. 5B and FIG. 5C are respectively graphs of rough detection and zoom detection of an output signal obtained by the radar distance measuring device according to the present embodiment. FIG. 6 is a view illustrating band examples of the BPF in the oversampling ΣΔADC.

In the operation according to the first embodiment, as well as FIG. 1 illustrating the basic configuration, the maximum distance measured by the radar distance measuring device 2 is also 150 m. In the present embodiment, a distance to an object X is also 150 m. Further, the radar distance measuring device 2 is allowed to change a band of the chirp signal between 1 GHz and 5 GHz.

Moreover, a repetition time of the chirp signal generated by the synthesizer 11 is set to 68 μs, and an oversampling frequency Fs of the ΣΔADC, which is each of the ADCs 18 and 23, is set to 640 MHz. An oversampling ratio OSR is variable between 2 and 16 in conjunction with the band of the chirp signal.

First, a bandwidth B of the chirp signal is set to 1 GHz as the rough detection, and radar is irradiated from the transmission antenna 13 to the object X. In this case, distance resolution dr is calculated as 15 cm from the formula “dr=c/2B”. Further, an IF frequency f0 becomes 15 MHz from the formula “f0=s2d/c”. The maximum IF frequency when the band of the chirp signal is 1 GHz is 15 MHz. Thus, as illustrated in FIG. 6A, by setting the band of the BPF the ΣΔADC to become 15 MHz, it is possible to reduce noise, and this makes it possible to obtain a high S/N ratio.

Since the Nyquist frequency of the ΣΔADC may be 20 MHz, the sampling frequency becomes 40 MHz, and the oversampling ratio OSR is set as 16. In a case where the oversampling ratio OSR is 16, it is not necessary to thin out data by the thinning circuits 24 and 25. For that reason, the selector 243 selects and outputs the input signal of the path “a” illustrated in FIG. 4 on the basis of the thinning control signal. Then, the distance to the object X can be found by the signal processing circuit provided at the post stage from the IF frequency f0 of the IF signal.

Next, in order to execute the zoom detection, the bandwidth B of Lite chirp signal is set to 5 GHz, whereby the distance resolution dr is made smaller. In this case, the distance resolution dr becomes 3 cm from the above formula, and the IF frequency f0 becomes 75 MHz from the above formula used for description of FIG. 1. Then, as illustrated in FIG. 6B, by setting the band of the BPF in the ΣΔADC to become 75 MHz, it is possible to reduce noise, and this makes it possible to obtain a high S/N ratio.

Since the Nyquist frequency of the ΣΔADC may be 160 MHz, the sampling frequency becomes 320 MHz, and the over sampling ratio OSR is set as 2. Here, the IF frequency f0 is known to be 75 MHz from a result of the rough detection. Thus, as illustrated in FIG. 4, the selector 243 selects and outputs the input signal of the path “f”, in which the BPF corresponds to 60 MHz to MHz and the thinning rate is ⅛, on the basis of the thinning control signal.

As described above, the similar processing is executed for all output channels, that is, channels of the reception antennas 14, 19, and . . . . Further, even in a case where the maximum distance to the object X is 150 m or shorter, the selector 243 selects any path through with a desired frequency component is caused to pass by means of the thinning control signal from the result of the rough detection in the same procedure.

<Features and Effects of First Embodiment>

Next, main features and main effects of the radar distance measuring device 2 according to the first embodiment will be described. In the radar distance measuring device 2 according to the present embodiment, in particular, an effect by increasing the distance resolution dr, an effect by using the BPF type ΣΔADC, and an effect by using the thinning circuits 24 and 25 will be described with reference to the drawings.

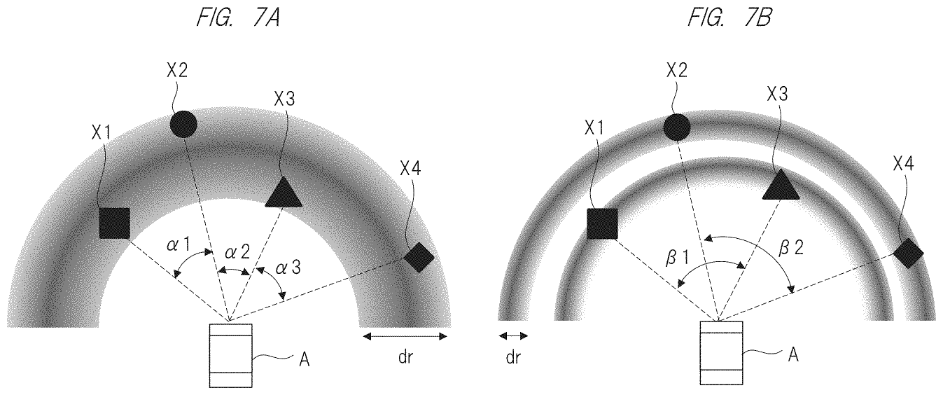

First, in the radar distance measuring device 2 according to the first embodiment, the feature and the effect by increasing the distance resolution will be described. Here, a relationship between the distance resolution and angle resolution will be described. with reference to FIG. 7. FIG.7 is a view illustrating a relationship between distance resolution and angle resolution.

Here, as illustrated in FIG. 7A, a case where there are four objects X1 to X4 in front of a vehicle A is considered. In a case where the distance resolution dr is low, all the objects X1 to X4 are included in a range of the distance resolution dr. Therefore, it is identified that the four objects X1 to X4 are substantially positioned at the same distance. For that reason, in order to separately identify these objects X1 to X4, it is necessary to separate them not only in a distance direction but also in an angle direction.

However, in order to increase the resolution in the angle direction, it is necessary to increase the number of receiving channels, that is, the number of circuit sets from. the reception antenna to the thinning circuit. If the number of receiving channels is increased, there is a problem that a manufacturing cost of the radar distance measuring device 2 is increased in accordance with the number of receiving channels. For example, in the example illustrated in FIG. 7A, the resolution of the angle direction between adjacent two of the four objects X1 to X4 is to be increased. Namely, in this case, it is necessary to increase the resolution in the angle direction with respect to three directions of angles α1, α2, and α3.

Therefore, when the distance resolution dr is increased by widening the bandwidth B of the chirp signal like the radar distance measuring device 2 according to the present embodiment, as illustrated in FIG. 7B, it is possible to separately identify a group of the objects X1 and X3 and a group of the objects X2 and X4. In this case, in order to separate the objects X1 and X3 from each other and separate the objects X2 and X4 from each other, it is necessary to further separate them by the angle direction. However, compared with the case illustrated in FIG. 7A, the resolution in the angle direction may be lower. By increasing the distance resolution in this manner, the resolution in the angle direction can be suppressed. Therefore, it is possible to obtain an effect that the manufacturing cost of the radar distance measuring device 2 can be reduced.

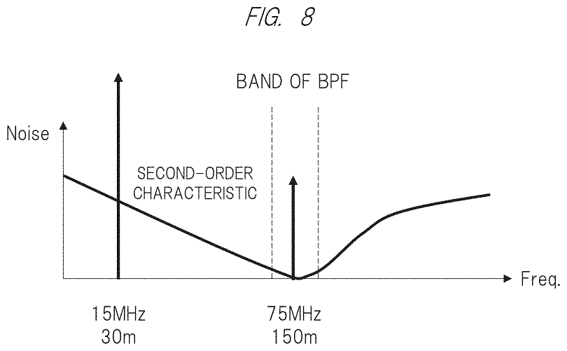

Next, the feature and the effect by using the BPF type ΣΔADC in the radar distance measuring device 2 according to the first embodiment will be described. Here, frequency characteristics at a lower side of the BPF will be described with reference to FIG. 8. FIG. 8 is a view illustrating frequency characteristics at a lower side of the BPF in the oversampling ΣΔADC.

It is assumed that the frequency characteristics of the BPF becomes those as illustrated in FIG. 8 when the bandwidth B of the chirp signal is set to 5 GHz. At this time, the frequency characteristics of the BPF are set so that a noise characteristic becomes small in the vicinity of 75 MHz corresponding to the maximum distance of 150 m. Due to such characteristics, problem that noise increases in the band of 75 MHz or lower occurs. However, due to characteristics of the radar, a frequency of 75 MHz or lower, that is, a chirp signal hit and reflected by an object that is located at a position closer than 150 m becomes larger with the square of the distance. For that reason, if the frequency dependency at the lower side of the BPF is a second-order characteristic or less, it is possible to receive the chirp signal without deteriorating the S/N ratio.

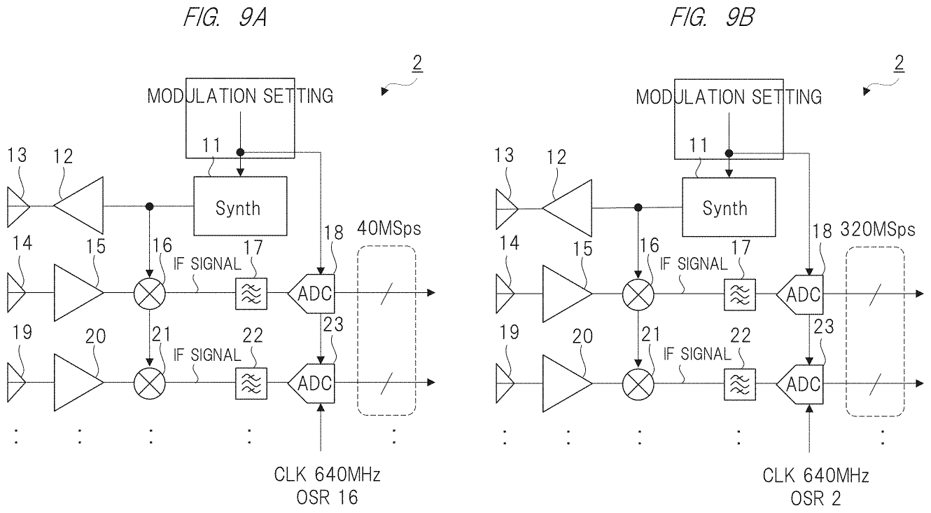

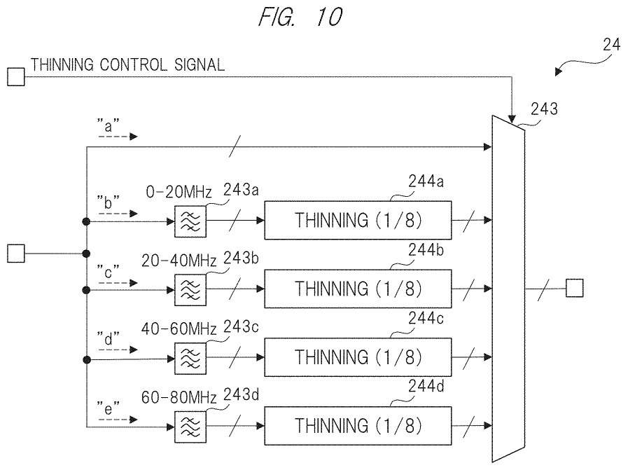

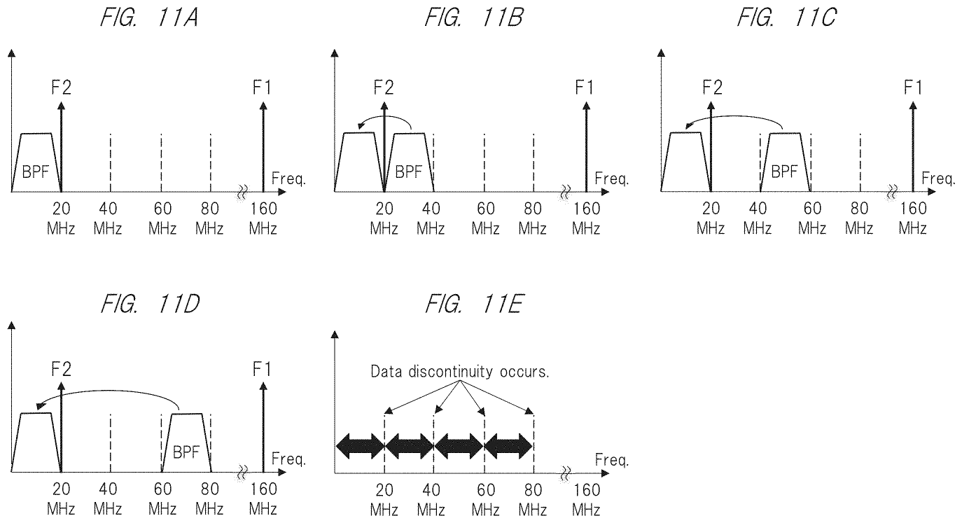

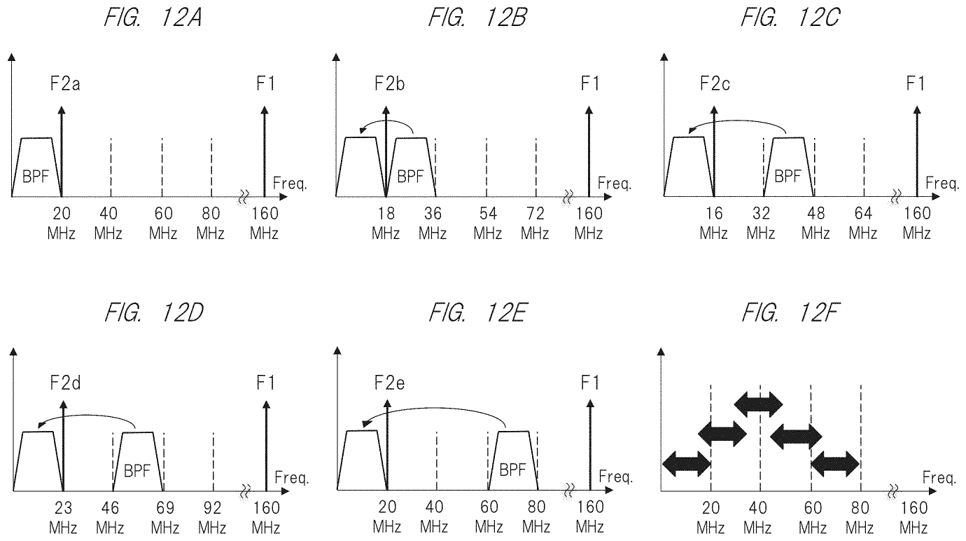

Finally, the feature and the effect by using the thinning circuits 24 and 25 in the radar distance measuring device according to the first embodiment will be described. Here, the feature and the effect by using the thinning circuits 24 and 25 will be described with reference to FIG. 9 to FIG. 12. FIG. 9 is a view illustrating a relationship between an oversampling ratio and a data rate of the oversampling FIG. 10 is a block diagram illustrating one example of a general thinning circuit. FIG. 11 is a view illustrating frequency characteristics when the general thinning circuit is used. FIG. 12 is a view illustrating frequency characteristics of a thinning circuit used in the radar distance measuring device according to the first embodiment.

As explained above, when the bandwidth B of the chirp signal is set to 1 GHz, the oversampling frequency Fs is 640 MHz, and the oversampling ratio OSR is 16. For that reason, as illustrated in FIG. 9A, data outputted from the ΣΔADC become 40 MSps (mega samples/second). On the other hand, when the bandwidth B of the chirp signal is set to 5 GHz, the oversampling frequency Fs is 640 MHz, and the oversampling ratio OSR is 2. For that reason, as illustrated in FIG. 9B, data outputted from the ΣΔADC become 320 MSps, and an amount of data is eight times compared with a case where the bandwidth B of the chirp signal is set to 1 GHz. Therefore, in the radar distance measuring device 2 according to the first embodiment, the data are thinned out for each necessary band, whereby the amount of data reduced until it becomes equivalent to that in a case where the chirp band is set to 1 GHz.

FIG. 10 illustrates a thinning circuit in a case where data are thinned out into ⅛ after simply passing through a decimation filter (that is, a BPF). FIG. 11 illustrates a frequency range thereof. As illustrated in FIG. 10, in paths “b” to “e”, there is no overlapping part at a boundary between any two of the bands each having a separate frequency. In this case, as illustrated in FIG. 11, the amount of data becomes ⅛ in each band, but there is a possibility that continuity of the data cannot be ensured at the boundary between any two of the bands. Therefore, as illustrated in FIG. 4, by not keeping the bandwidth and the thinning rate of the decimation filter constant, as illustrated in FIG. 12, it is possible to provide the overlapping parts at the boundary between any two of the bands of the frequency, and this makes it possible to ensure the continuity of the data.

### Second Embodiment

Next, a second embodiment will be described. Note that the same reference numeral is assigned to each unit that has the similar function to that according to the first embodiment, and in principle, explanation thereof will be omitted. In the first embodiment, the synthesizer 11 and the ADCs 18 and 23 are controlled for setting the modulation band. In the present embodiment, a case where a correction circuit for a BPF is further provided between each of ADCs 18 and 23 and the corresponding one of thinning circuits 24 and 25, and these correction circuits are also controlled for setting a modulation band will be described.

<Configuration of Radar Distance Measuring Device>

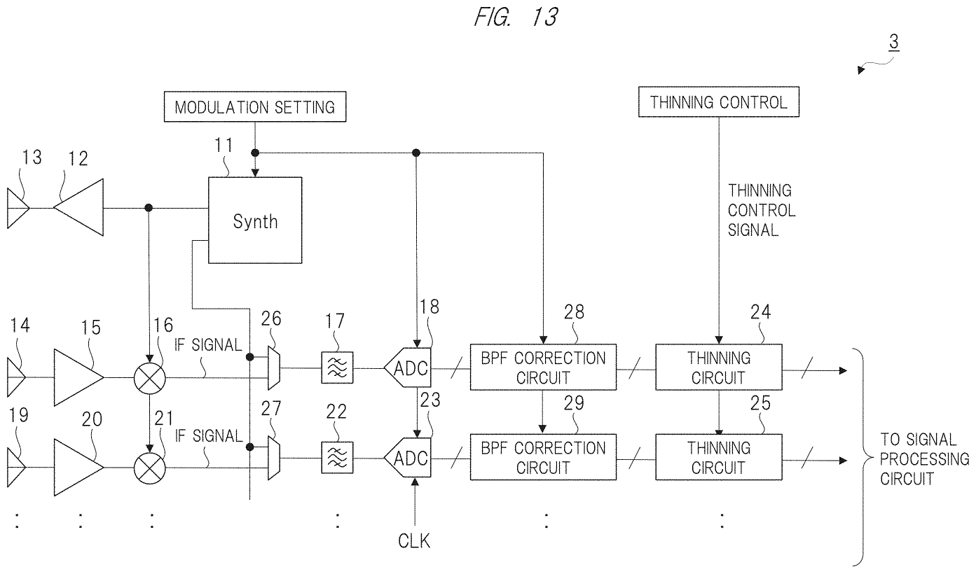

One example of a configuration of a radar distance measuring device according to the second embodiment will first be described. FIG. 13 is a block diagram illustrating one example of a configuration of a radar distance measuring device according to the second embodiment. The present embodiment is different from the configuration according to the first embodiment in that a BPF correction circuit is inserted between each of the ADCs 18 and 23 and the corresponding one of the thinning circuits 24 and 25. Further, another difference is that a chirp signal from a synthesizer 11 can directly be inputted into anti-aliasing filters 17 and 22 by adding a selector to a next stage of mixers 16 and 21.

As illustrated in FIG. 13, a radar distance measuring device 3 according to the present embodiment includes a synthesizer 11, a power amplifier 12, a transmission antenna 13, two reception antennas 14 and 19, two low noise amplifiers 15 and 20, two mixers 16 and 21, two anti-aliasing filters 17 and 22, two ADCs 18 and 23, two thinning circuits 24 and 25, two selectors 26 and 27, and two BPF correction circuits 28 and 29. Here, each of the selectors 26 and is configured so as to select any one of a chirp signal generated by the synthesizer 11 and an IF signal outputted from each of the mixers 16 and 21 to output the selected one to the corresponding anti-aliasing filter 17 or 22. Further, each of the BPF correction circuits 28 and 29 is configured by a digital circuit configured to execute signal processing.

The synthesizer 11 is configured so as to output a continuous wave as a reference necessary for correction at a post stage in addition to the generated chirp signal. Hts continuous wave as the reference is variable in an IF frequency band to be used (here, up to 80 MHz) depending upon settings of the synthesizer 11.

In a calibration mode to execute settings for the BPF correction circuits 28 and 29, selection of the selectors 26 and 27 is switched so that the chirp signal is directly inputted into the anti-aliasing filters 17 and 22. Then, the continuous wave outputted from the synthesizer 11 is swept to 80 MHz, whereby a frequency dependent characteristic of a BPF in a ΣΔADC constituting each of the ADCs 18 and 23 is obtained by the BPF correction circuits 28 and 29. The similar processing is executed for the BPF correction circuits 28, 29, and . . . respectively provided in all channels at a reception side, and the average of BPF frequency characteristics is summarized. Then, a difference from the average calculated in each receiving channel, and the calculated difference is used as a correction value.

In a case where a distance is measured by the radar distance measuring device 3, as well as the case of the radar distance measuring device 2 according to the first embodiment, the synthesizer 11 generates and outputs a chirp signal, and the selectors 26 and 27 respectively provided at next stages of the mixers 16 and 21 selects an IF signal so that the IF signals, which are output signals of the mixers 16 and 21 are respectively inputted into the anti-aliasing filters 17 and 22 instead of the chirp signal. The IF signals obtained by being sampled by the ΣΔADCs respectively constituting the ADCs 18 and 23 are corrected by using the correction values calculated in the calibration mode described above by the BPF correction circuits 28 and 29.

<Features and Effects of Second Embodiment>

Next, main features and main effects of the radar distance measuring device 3 according to the second embodiment will be described.

As illustrated in FIG. 13, features of the radar distance measuring device 3 according to the present embodiment are that the BPF correction circuits 28 and 29 are provided in the radar distance measuring device 3, and the IF signals sampled by the ΣΔADCs respectively constituting the ADCs 18 and 23 are corrected by using the correction values calculated in the calibration mode.

The BPF in the ΣΔADC is usually configured by a resistance element and a capacitance element. For that reason, the BPF frequency characteristics may vary among the receiving channels due to variations in the performance of each element. Since the radar distance measuring device 3 has the configuration as described above, the BPF correction circuits 28 and 29 allows the variations of the BPF to be canceled to execute the signal processing, and this makes it possible to improve accuracy of distance measurement and angle measurement.

### Third Embodiment

Next, a third embodiment will be described. Note that hereinafter, the same reference numerals are respectively assigned to components having the similar functions to those in the first embodiment or the second embodiment, and explanation thereof will be omitted in principle. In the second embodiment, the BPF correction circuits 28 and 29 are respectively inserted between the ADCs 18 and 23 and the thinning circuits 24 and 25. The present embodiment is different from the second embodiment in that BPF correction circuits 28 and 29 are respectively inserted at post stages of thinning circuits 24 and 25.

<Configuration of Radar Distance Measuring Device>

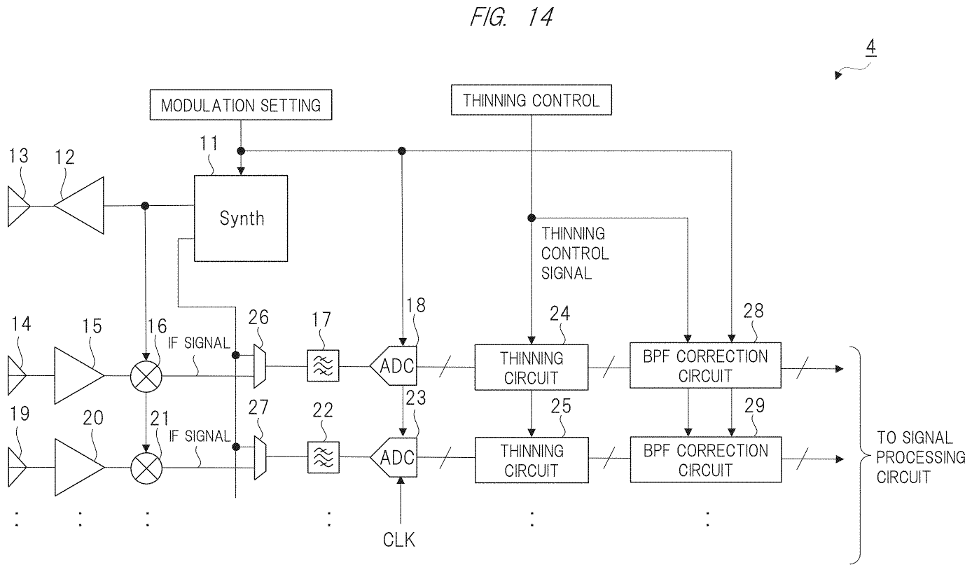

One example of a configuration of a radar distance measuring device according to the third embodiment will first be described. FIG. 14 is a block diagram illustrating one example of a configuration of a radar distance measuring device according to the third embodiment. Compared with the configuration according to the second embodiment, the present embodiment is different therefrom in that BPF correction circuits are not respectively inserted between ADCs 18 and 23 and thinning circuits 24 and 25, but are respectively inserted at post stages of the thinning circuits 24 and 25.

As illustrated in FIG. 14, a radar distance measuring device 4 according to the present embodiment includes a synthesizer 11, a power amplifier 12, a transmission antenna 13, two reception antennas 14 and 19, two low noise amplifiers 15 and 20, two mixers 16 and 21, two anti-aliasing filters 17 and 22, two ADCs and 23, two thinning circuits 24 and 25, two selectors 26 and 27, and two BPF correction circuits 28 and 29. Here, each of the selectors 26 and 27 and the BPF correction circuits 28 and 29 is arranged differently, but has the similar configuration of corresponding one of the selectors 26 and 27 and the BPF correction circuits 28 and 29 according to the second embodiment.

Note that an operation of the radar distance measuring device 4 according to the third embodiment is similar to the operation of the radar distance measuring device 3 according to the second embodiment, and thus, explanation thereof will be omitted. However, in a calibration mode to execute settings of the BPF correction circuits 28 and 29, in order to cause the thinning circuits 24 and 25 to output input signals thereto as they are, a selector 243 and the like (not illustrated in FIG. 14) in the thinning circuits 24 and 25 selects and outputs an input signal through the path “a” illustrated in FIG. 4 on the basis of a thinning control signal.

<Features and Effects of Third Embodiment.>

Next, main features and main effects of the radar distance measuring device 4 according to the third embodiment will be described.

As well as the second embodiment, features of the radar distance measuring device 4 according to the present embodiment are that the BPF correction circuits 28 and 29 are provided in the radar distance measuring device 4, and IF signals sampled by ΣΔADCs respectively constituting the ADCs 18 and 23 are corrected by using correction values calculated in the calibration mode.

Since the radar distance measuring device 4 has the configuration as described above, as well as the second embodiment, the BPF correction circuits 28 and 29 allows the variations of the BPF to be canceled to execute the signal processing, and this makes it possible to improve accuracy of distance measurement and angle measurement. Further, by respectively moving the BPF correction circuits 28 and 29 to the post stages of the thinning circuits 24 and 25, it is possible to reduce an amount of data to be inputted into the BPF correction circuits 28 and 29, and there is an effect that calculation processing speed does not need to be increased by the reduction of the amount of data. This makes it possible to reduce a manufacturing cost of the radar distance measuring device 4.

As described above, the invention made by the inventors of the present application has been described specifically on the basis of the embodiments. However, the present invention is not limited to the first to third embodiments described above, and it goes without saying that the present invention may be modified into various forms without departing from the substance thereof.

For example, the case where each unit of the thinning circuits 24 and 25 is configured by hardware has been described in the first to third embodiments. However, the present invention is not limited to such a configuration. The control for each of the units may be configured by dedicated software so long as cost the cost thereof is acceptable, for example.

Further, the case where the distance and the angle to the object are measured by two systems (that is, the two channels are the reception side) has been described in the first to third embodiments. However, the present invention is not limited to such a configuration. For example, in order to measure the distance and the angle more accurately, the number of channels at the reception side may be increased for the plurality of objects as illustrated in FIG. 7 so long as cost the cost thereof is acceptable.

What is claimed is:

1. A radar distance measuring device for measuring at least one of a distance or an angle to an object by radar, the radar distance measuring device comprising:
a synthesizer configured to generate and output a chirp signal;
a transmission antenna configured to irradiate the chirp signal generated by the synthesizer to an object as radar;
one or more reception antennas configured to receive the chirp signal reflected by the object;
one or more mixers configured to mix the chirp signal generated by the synthesizer with the chirp signal reflected by the object to generate an intermediate frequency signal; and
one or more AD converters configured to convert the intermediate frequency signal into a digital signal,
wherein each of the one or more AD converters is a bandpass filter type ΣΔADC in which a bandpass filter is embedded, and the ΣΔADC is configured to sample the intermediate frequency signal on a bass of two bands of the bandpass filter.

2. The radar distance measuring device according to claim 1,
wherein a frequency band and an oversampling ratio of the bandpass filter in the ΣΔADC are controlled in conjunction with a modulation bandwidth of the chirp signal.

3. The radar distance measuring device according to claim 2,
wherein the frequency band and the oversampling ratio of the bandpass filter in the ΣΔADC are determined so as to minimize noise in a predetermined frequency band of the bandpass filter in the ΣΔADC in accordance with the modulation bandwidth of the chirp signal.

4. The radar distance measuring device according to claim 1,
wherein an oversampling ratio of the ΣΔADC takes any of at least two values in different magnitudes, and
wherein the radar distance measuring device further comprises:
one or more thinning circuits configured to reduce an amount of data of the digital signal converted by the ΣΔADC in a case where the oversampling ratio is set to the smaller value.

5. The radar distance measuring device according to claim 1,
wherein one of the one or more reception antennas, one of the one or more mixers, and one of the one or more AD converters are provided for one of the reception antennas to form a channel, and
wherein the radar distance measuring device further comprises:
a correction circuit configured to correct a characteristic difference among channels of the bandpass filter in the ΣΔADC.

6. The radar distance measuring device according to claim 2,
wherein one of the one or more reception antennas, one of the one or more mixers, and one of the one or more AD converters are provided for one of the reception antennas to form a channel,
wherein the oversampling ratio of the ΣΔADC takes any of at least two values in different magnitudes,
wherein the radar distance measuring device further comprises:
one or more thinning circuits configured to reduce an amount of data of the digital signal converted by the ΣΔADC in a case where the oversampling ratio is set to the smaller value; and
a correction circuit configured to correct a characteristic difference among channels of the bandpass filter in the ΣΔADC, and
wherein the correction circuit is provided between the one or more AD converters and the one or more thinning circuits or at a post stage of the one or more thinning circuits.

7. A radar distance measuring method of measuring at least one of a distance or an angle to an object by radar, the radar distance measuring method comprising:
generating and output a chirp signal;
irradiating the generated chirp signal to an object as radar;
receiving the chirp signal reflected by the object;
mixing the generated chirp signal with the chirp signal reflected by the object to generate an intermediate frequency signal; and
converting the intermediate frequency signal into a digital signal by controlling a frequency band and an oversampling ratio of a bandpass filter from which the intermediate frequency signal is outputted in conjunction with a modulation bandwidth of the chirp signal.
